(19) United States
(12) Patent Application Publication
(10) Pub. No.: US 2021/0316619 A1
(43) Pub. Date: Oct. 14, 2021

(54) BATTERY

(71) Applicant: Mahle International GmbH, Stuttgart (DE)

(72) Inventors: Peter Geskes, Ostfildern (DE); Eduard Reimer, Fellbach (DE); Joachim Treier, Oppenau (DE); Johannes Weinmann, Stuttgart (DE)

(21) Appl. No.: 17/226,020

(22) Filed: Apr. 8, 2021

(30) Foreign Application Priority Data
Apr. 9, 2020 (DE) 10 2020 204 637.9

(51) Int. Cl. B60L 50/64; B60K 1/04; B60K 11/02; H01M 10/613; H01M 10/625; H01M 10/6556; H01M 10/647; H01M 50/209

(52) U.S. Cl. CPC B60L 50/64; B60K 1/04; B60K 11/02; H01M 10/613; B60K 2001/005; H01M 10/6556; H01M 10/647; H01M 50/209; H01M 10/625

(57) ABSTRACT

A battery may include a housing having two longitudinal walls aligned transversely to a width direction and at least two transverse walls aligned transversely to a longitudinal direction, the housing being delimited towards the outside by the longitudinal and transvers walls. The battery may also include at least one battery stack of multiple individual cells stacked against one another in a stack direction, the battery stack being received in the housing between the longitudinal walls and the transverse walls following one another in the longitudinal direction. The battery may further include at least one cooler through which a cooling liquid is flowable and which on an outside heat-transferringly lies against a cooled one of the longitudinal walls. Each battery stack may be heat-insulated from the cooled longitudinal wall and may heat-transferringly lie against the transverse walls adjacent to the respective battery stack.

### CROSS-REFERENCE TO RELATED APPLICATIONS

This application claims priority to German Patent Application No. DE 10 2020 204 637.9, filed on Apr. 9, 2020, the contents of which is hereby incorporated by reference in its entirety.

### TECHNICAL FIELD

The invention relates to a battery for a motor vehicle.

### BACKGROUND

In a battery-operated motor vehicle, a battery is employed as source of energy. The battery comprises multiple battery stacks of multiple individual cells which are electrically interconnected interconnected and usually arranged in a stack housing. The battery stacks with the stack housings are then arranged in a battery housing next to one another and electrically interconnected. In the case of small batteries, such as are used for example in hybrid motor vehicles, the individual stack housings can be dispensed with. In order to improve the efficiency of the individual cells in the battery, the individual cells should be operated in a narrow temperature range. To this end, the individual cells in the battery stack are usually temperature-controlled. From DE 10 2009 035 492 A1 it is known for example to integrate in the stack housing a cooling plate that can be flowed through by the fluid. Here, the cooling plate lies against the individual cells on one side and in a heat-transferring manner so that the individual cells can be cooled.

Disadvantageously, even cooling of the individual cells in the battery stack cannot be conventionally achieved. Depending on the arrangement of the cooling plate on the battery stack, the heat transfer takes place only on one side or only on the outer individual cells of the battery stack. In both cases, temperature differences develop within the individual cells and/or in the individual cells within the battery stack. Because of this, the efficiency of the individual cells and of the battery as a whole is diminished and the lifespan of the battery additionally shortened.

### SUMMARY

The object of the invention therefore is to state for a battery of the generic type an improved or at least alternative embodiment, with which the described disadvantages are overcome. In particular, the cooling of the individual cells in the battery is to be improved and an even temperature distribution in the battery stack achieved.

According to the invention, this object is solved through the subject matter of the independent claim(s). Advantageous embodiments form the subject matter of the dependent claim(s).

A battery is provided for a motor vehicle which can be an electric motor vehicle or a hybrid motor vehicle. The battery comprises a housing which has two longitudinal walls and at least two transverse walls. Here, the longitudinal walls are aligned transversely to the width direction of the housing. Accordingly, the longitudinal walls are aligned parallel to the longitudinal direction and parallel to one another. The transverse walls are aligned transversely to the longitudinal direction of the housing. Accordingly, the transverse walls are aligned parallel to the width direction and parallel to one another. Here, the housing is delimited towards the outside by the two longitudinal walls and by two of the transverse walls. Furthermore, the battery comprises at least one battery stack of multiple individual cells which are stacked against one another in the stack direction. The individual cells can be prismatic cells or pouch cells or cylindrical cells. Here, the battery stack is received in the housing between the longitudinal walls and the transverse walls following one another in the longitudinal direction. In other words, the battery stack is arranged in the width direction adjacent to the longitudinal walls and in the longitudinal direction adjacent to the respective transverse walls. In addition, the battery comprises at least one cooling device that can be flowed through by a cooling liquid which on the outside heat-transferringly lies against one of the longitudinal walls. According to the invention, the respective battery stack is heat-insulated from the cooled longitudinal wall of the housing and heat-transferringly lies against the transverse walls adjacent to it.

In the battery according to the invention, a direct and large-area heat transfer between the cooled longitudinal wall and the battery stack is prevented through the heat insulation. The individual cells of the battery stack lying against the cooled longitudinal wall are thus cooled to a lesser degree than conventionally. The heat transfer between the cooling device and the battery stack then takes place via the transverse walls and the battery stack is cooled on both sides and evenly. Altogether, an even temperature distribution in the battery stack is achieved and the cooling of the battery stack improved. The longitudinal walls and the transverse walls are practically formed from a heat-transferring material and heat-transferringly connected to one another, so that the heat transfer can take place between the cooling liquid and the cooled longitudinal wall and between the cooled longitudinal wall and the transverse walls.

Advantageously, the battery stack can be received in the housing so that the stack direction of the individual cells in the respective battery stack coincides with the width direction of the housing. In other words, the individual cells in the battery stack can be aligned transversely to the width direction. The respective individual cell of the battery stack then lies against the transverse wall on one side and against the other transverse wall on the other side and is cooled on both sides. Alternatively, the battery stack can be received in the housing so that the stack direction of the individual cells in the respective battery stack coincides with the longitudinal direction of the housing. In other words, the individual cells in the battery stack can be aligned transversely to the longitudinal direction. The individual cells of the battery stack located outside then lie against the transverse walls and are cooled over their entire area.

In an advantageous embodiment of the battery it is provided that between the respective cooled longitudinal wall and the at least one battery stack an insulating element of a heat-insulating material is arranged. Here, the insulating element lies against the at least one battery stack on one side and against the respective cooled longitudinal wall on the other side. The heat-insulating material can be for example a heat-insulating plastic or a heat-insulating plastic foam. Here, the insulating element can be fixed—for example glued—to the cooled longitudinal wall or on the battery stack. Advantageously, the insulating element can be an insulating plate. By way of the insulating plate, a region between the at least one battery stack and the respective cooled longitudinal wall can then be completely filled out. Alternatively, the insulating element can have a rib structure with multiple ribs spaced apart from one another. In a region between the at least one battery stack and the respective cooled longitudinal wall, multiple heat-insulating part regions filled with ambient air can then be formed between the ribs.

In this embodiment, the heat transfer between the transverse walls and the battery stack can be improved through a heat-conductive paste or through a heat conduction plate. The heat-conductive paste or the heat conduction plate can be arranged to this end in regions between the respective transverse wall and the battery stack. The heat conduction plate is practically formed of a heat-conductive material and can comprise a rib structure or a closed plate structure.

In an alternative embodiment of the battery it is provided that the battery stack is received in a support cage of a heat-insulating material. The heat-insulating material can be a heat-insulating plastic or a heat-insulating plastic foam. Here, the support cage comprises a cage longitudinal wall each towards the respective longitudinal wall which is frame-like or grid-like or closed. In other words, the support cage comprises two cage longitudinal walls located opposite one another, which are arranged adjacently to the respective longitudinal walls. In addition, the support cage comprises a cage transverse wall each towards the respective transverse wall with an open heat transfer region. In other words, the support cage comprises two cage transverse walls located opposite one another, which are arranged adjacently to the respective transverse walls.

The battery stack in the support cage is heat-insulated from the longitudinal walls by the cage longitudinal walls, so that an undercooling of the battery stack and the individual cells on the respective cooled longitudinal wall is prevented. Thus, the cage longitudinal walls in the support cage represent an insulating element according to the embodiment described above. By contrast, the battery stack is heat-transferringly connected to the transverse walls via the open heat transfer regions of the cage transverse walls. Because of this, the heat transfer between the cooling device and the battery stack can take place via the transverse walls. The support cage can comprise a bottom and because of this form a stable housing structure in which the battery stack with the individual cells is received. Such a support cage can facilitate the stacking of the individual cells to form the battery stack and the assembly of the battery stack in the housing.

Advantageously, the heat transfer region can be formed centrally in the cage transverse wall and be delimited radially to the longitudinal direction by a surrounding rim of the cage transverse wall. In this embodiment, the support cage encloses the battery stack at the cage transverse walls only on the rim side, so that the heat transfer through the heat-insulating material of the support cage is not prevented. Advantageously, the open heat transfer region of the cage transverse wall between the battery stack and the respective adjacent transverse wall can be filled with a heat-conductive paste. Alternatively, a filler plate of a heat-conductive material with a rib structure or with a closed plate structure can be arranged in the open heat transfer region of the cage transverse wall between the battery stack and the respective adjacent transverse wall. Here it is conceivable that the cage and the filler plate are embodied as a hybrid component. The heat transfer between the respective transverse wall and the battery stack can be improved through the heat-conductive paste or the filler plate.

Advantageously it can be provided that the longitudinal walls and the transverse walls are integrally formed as a housing profile. The housing profile can be produced for example by way of extrusion. The housing can additionally comprise two cover plates which delimit the housing transversely to the height direction towards the outside and are connected to the housing profile. For example, the cover plates can be welded or screwed or glued to the housing profile. Depending on the arrangement of the cover plates, the cover plates form a bottom and a cover in the housing. Thus, the housing can be delimited towards the outside on all sides and the respective battery stack can be securely received in the housing because of this.

Advantageously it can be provided that the housing is formed of a casting, such as for example a die casting. Here, the longitudinal walls and the transverse walls of the housing can be formed integrally with a bottom of the housing as a housing part. In addition, the housing can comprise a cover plate which delimits the housing part transversely to the height direction towards the outside and is connected to the housing part. The housing part and the cover plate can both or individually be formed of a casting, such as for example a die casting.

Alternatively, the transverse walls and the longitudinal walls can be formed from plate and be firmly connected to one another to form a plate structure—for example by welding. Alternatively, the longitudinal walls and the transverse walls can be formed as extruded components and fixed to one another—for example by welding. The two cover plates described above are then fixed to the plate structure or correspondingly to the firmly connected extruded components.

Advantageously, the battery can comprise multiple battery stacks and multiple transverse walls. Each battery stack is then arranged between two transverse walls following one another in the longitudinal direction and heat-transferringly lies against these. Here, the individual transverse walls are each aligned transversely to the longitudinal direction and parallel to one another. Two transverse walls located outside then delimit the housing transversely to the longitudinal direction towards the outside and remaining transverse walls are arranged within an interior space of the housing. Through the remaining transverse walls the interior space is divided into multiple individual spaces wherein in the respective individual space one of the multiple battery stacks each is received. Advantageously, an electronic unit for controlling the battery or the multiple battery stacks can also be received in one of the individual spaces. The transverse walls within the interior space additionally stiffen the housing of the battery so that the housing has a better crash performance.

Advantageously it can be provided that the cooling device lies on the respective longitudinal wall with the full surface area and is material-bonded to the respective longitudinal walls. Accordingly, the cooling device can be for example friction-welded or laser-welded or glued or inert gas-welded to the longitudinal wall. In addition, at least one cooling channel can be formed in the cooling device which is open towards the respective longitudinal wall and closed towards the outside by the respective longitudinal wall. In other words, the respective longitudinal wall is directly impinged by the cooling liquid and because of this the heat transfer between the cooling liquid and the respective longitudinal wall can be improved.

Advantageously, the battery can comprise two cooling devices which, each heat-transferringly lie against the one longitudinal wall on the outside. Practically, the at least one battery stack is then heat-insulated from each of the longitudinal walls.

Further important features and advantages of the invention are obtained from the subclaims, from the drawings and from the associated figure description by way of the drawings.

It is to be understood that the features mentioned above and still to be explained in the following cannot only be used in the respective combination stated but also in other combinations or by themselves without leaving the scope of the present invention.

Preferred exemplary embodiments of the invention are shown in the drawings and are explained in more detail in the following description, wherein same reference numbers relate to same or similar or functionally same components.

### BRIEF DESCRIPTION OF THE DRAWINGS

It shows, in each case schematically

FIG. 1 shows a view of a housing of a battery according to the invention;

FIG. 2 shows a view of the housing of the battery according to the invention with received battery stacks;

FIG. 3 shows an exploded view of the housing of the battery according to the invention with a battery stack;

FIG. 4 shows an exploded view of the housing of the battery according to the invention.

### DETAILED DESCRIPTION

FIG. 1 shows a view of a housing 2 of a battery 1 according to the invention for an electric motor vehicle or a hybrid motor vehicle. FIG. 4 shows an exploded view of the housing 2 of the battery 1 according to the invention. In the housing 2, a longitudinal direction LR, a width direction BR and a height direction HR are defined, which are aligned perpendicularly to one another. The housing 2 comprises two longitudinal walls 3 aligned transversely to the width direction BR and in this exemplary embodiment 6 transverse walls 4 aligned transversely to the longitudinal direction LR. The individual transverse walls 4 are aligned parallel to and spaced apart from one another. Through the transverse walls 4, the housing 2 of the battery 1 is stiffened and because of this has a better crash performance. The housing 2 is delimited towards the outside by two transverse walls located outside and the two longitudinal walls 3. Four transverse walls 4 located inside are arranged in an interior space 4 of the housing 2, as a result of which the interior space 5 is divided into four individual spaces 6a that are identical to one another and a larger individual space 6b. The individual spaces 6a are provided for receiving battery stacks and the individual spaces 6b for receiving an electronic unit.

The longitudinal walls 3 and the transverse walls 4 are integrally formed as an extruded housing profile 8. Practically, the housing profile 8 is formed from a heat-conductive material—for example metal. In addition, the housing 2 comprises two cover plates 7a and 7b which delimit the housing 2 transversely to the height direction HR towards the outside. For the sake of clarity, the housing 1 is shown without the cover plate 7a in FIG. 1. The cover plates 7a and 7b are connected to the housing profile 8 and can be welded or screwed or glued to the same for example. The cover plates 7a and 7b are identical to one another and form a cover and a bottom in the housing 2. The housing 2 with the integral housing profile 8 and with the identical cover plates 7a and 7b is constructed in a particularly simple and cost-effective manner.

In addition, the battery 1 in this exemplary embodiment comprises two identical cooling devices 9 which can each be flowed through by a cooling liquid. The respective cooling device 9 lies with the full surface area and heat-transferringly against the respective longitudinal wall 3 on the outside and extends only over the individual spaces 6a. The cooling device 9 is material-bonded to the respective longitudinal wall 3 and can be friction-welded or laser-welded or glued to the same. In the respective cooling device 9 a cooling channel 10 is formed in which the cooling liquid is conducted from an inlet 11a to an outlet 11b on the respective longitudinal wall 3.

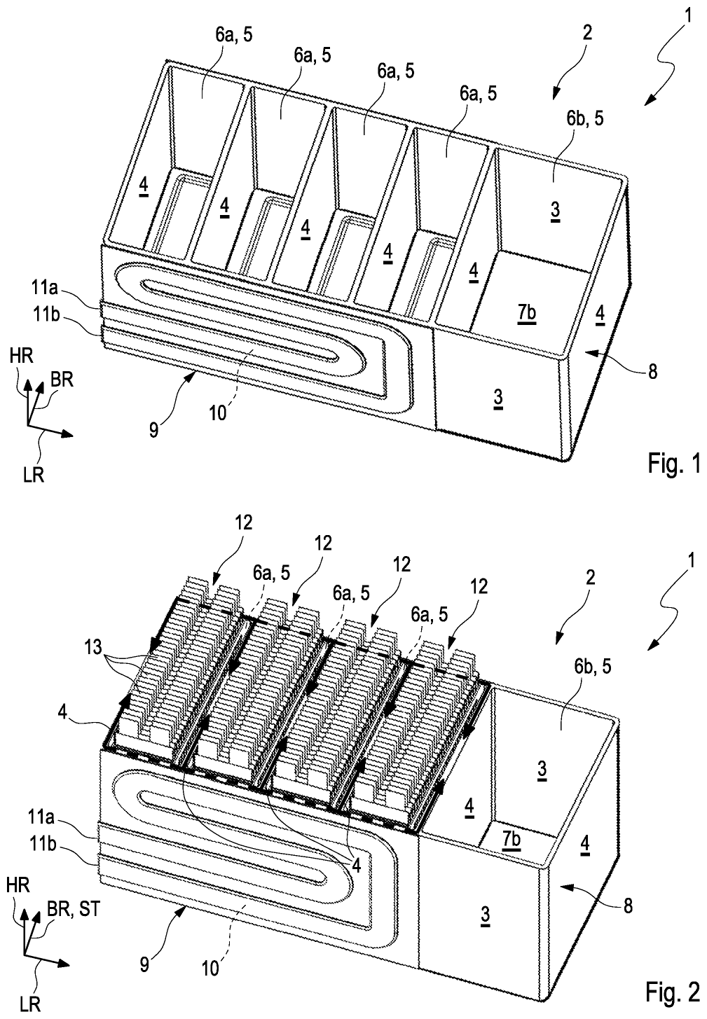

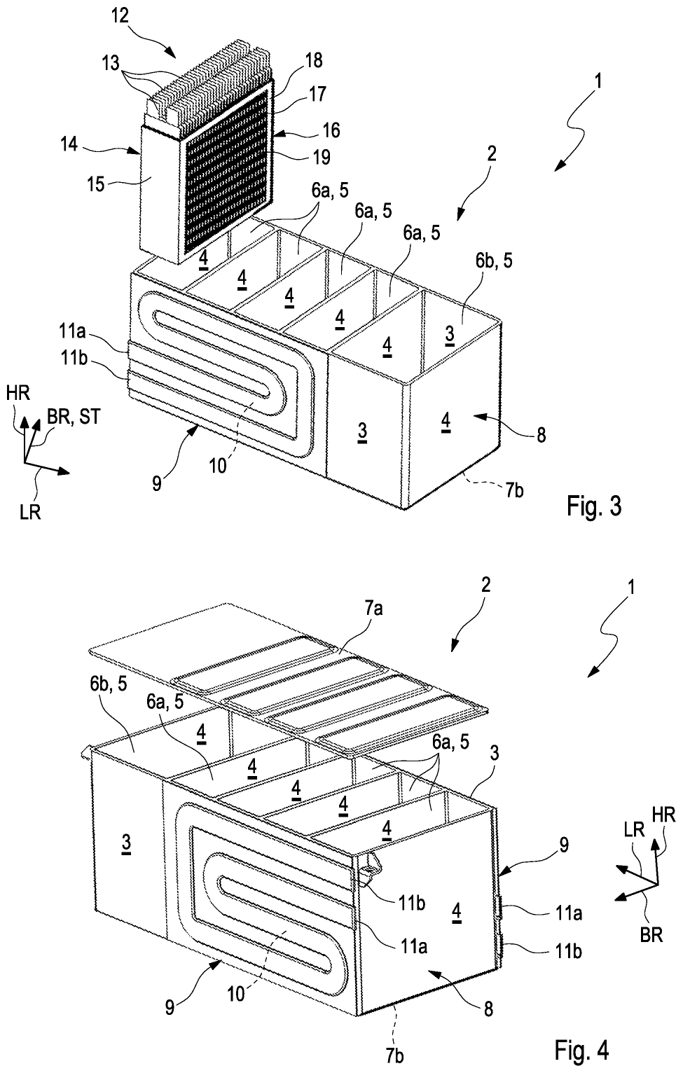

FIG. 2 shows a view of the housing 2 with battery stacks 12. FIG. 3 shows an exploded view of the housing 2 with one of the received battery stacks 12. In this exemplary embodiment, the battery 1 comprises a total of four battery stacks 12 which are individually received in the individual spaces 6a. The respective battery stack 12 is thus arranged between the longitudinal walls 3 and between two transverse walls 4 following one another in the longitudinal direction LR. Here, the respective battery stack 12 comprises multiple individual cells 13 which are stacked in a stack direction ST. In this exemplary embodiment, the stack direction ST corresponds to the width direction BR of the housing 2. Accordingly, the individual cells are aligned transversely to the width direction BR.

With reference to FIG. 3, the respective battery stack 12 is received in a support cage 14 of a heat-insulating material—for example plastic or plastic foam. Here, the support cage 14 comprises two cage longitudinal walls 15 located opposite one another, which face the respective longitudinal walls 3 of the housing 2. In addition, the support cage 14 comprises two cage transverse walls 16 located opposite one another, which face the respective transverse walls 4 of the housing 2. The cage longitudinal walls 15 are closed so that the individual cells 13 of the battery stack 12 are heat-insulated from the respective cooled longitudinal wall 3. In the respective cage transverse walls 16, by contrast, open heat transfer regions 17 are formed. On the cage transverse walls 16, the support cage 14 encloses the battery stack 12 by way of a surrounding rim 18, i.e. only on the rim side. In the open heat transfer regions 17 of the cage transverse walls 16, filler plates 19 of a heat-conductive material are arranged. Alternatively, the open heat transfer regions 17 of the cage transverse walls 16 can be filled with a heat-conductive paste.

With reference to FIG. 4, the battery stacks 12 with the support cages 14 are arranged in the associated individual spaces 6a of the housing 2. The cage longitudinal walls 15 are located between the respective cooled longitudinal walls 3 and the battery stack 12 or the individual cells 13 of the battery stack 12. The support cage 14 and its cage longitudinal walls 15 are heat-insulating, so that the battery stack 12 or the individual cells 13 of the battery stack 12 are heat-insulated from the respective cooled longitudinal walls 3. The cage transverse walls 16 are located between the respective transverse walls 4 and the battery stack 12 or the individual cells 13 of the battery stack 12. The filler plates 19 in the heat transfer regions 17 of the cage transverse walls 16 are heat-conductive, so that the transverse walls 4 are heat-conductively connected to the battery stack 12 or to the individual cells 13 of the battery stack 12.

As is indicated with dashed lines in FIG. 4, a direct and large surface-area heat transfer between the cooled longitudinal walls 3 and the battery stacks 12 is prevented in the battery 1. The heat transfer is effected through the transverse walls, as illustrated with arrows in FIG. 4. Altogether, an undercooling of the outer individual cells 13 of the battery stack 12 can thus be prevented and an even and effective cooling of the individual cells 13 in the battery stack 12 achieved.

1. A battery for a motor vehicle, comprising:
a housing having two longitudinal walls aligned transversely to a width direction and at least two transverse walls aligned transversely to a longitudinal direction, the housing being delimited towards the outside by the longitudinal walls and the transverse walls;
at least one battery stack of multiple individual cells, which are stacked against one another in a stack direction, the battery stack being received in the housing between the longitudinal walls and the transverse walls following one another in the longitudinal direction; and
at least one cooler through which a cooling liquid is flowable and which on an outside heat-transferringly lies against a cooled one of the longitudinal walls;
each battery stack is heat-insulated from the cooled longitudinal wall of the housing and heat-transferringly lies against the transverse walls adjacent to the respective battery stack.

2. The battery according to claim 1, wherein between the cooled longitudinal wall and the at least one battery stack, an insulating element of a heat-insulating material is arranged, and the insulating element on one side lies against the at least one battery stack and on the other side against the cooled longitudinal wall.

3. The battery according to claim 2, wherein one of:
the insulating element is an insulating plate, so that a region between the at least one battery stack and the cooled longitudinal wall is completely filled out by the insulating plate or
the insulating element has a rib structure with multiple ribs spaced apart from one another, so that in a region between the at least one battery stack and the cooled longitudinal wall multiple heat-insulating part regions filled with ambient air are formed.

4. The battery according to claim 1, wherein the at least one battery stack is received in a support cage of a heat-insulating material, wherein the support cage, towards the respective longitudinal wall, has a frame-like or grid-like or closed cage longitudinal wall each, and towards the respective transverse wall, a cage transverse wall with an open heat transfer region each.

5. The battery according to claim 4, wherein the heat transfer region is formed in the middle of the cage transverse wall and is delimited radially to the longitudinal direction by a surrounding rim of the cage transverse wall.

6. The battery according to claim 4, wherein:
the open heat transfer region of the cage transverse wall between the battery stack and the respective adjacent transverse wall is filled with a heat-conductive paste; or
in the open heat transfer region of the cage transverse wall, between the battery stack and the respective adjacent transverse wall, a filler plate of a heat-conductive material with a rib structure or with a closed plate structure is arranged, wherein the filler plate and the cage are formed as a contiguous hybrid component.

7. The battery according to claim 1, wherein the stack direction of the individual cells in the respective battery stack coincides with the width direction of the housing.

8. The battery according to claim 1, wherein:
the longitudinal walls and the transverse walls are integrally formed as a housing profile; and
the housing comprises two cover plates, which delimit the housing transversely to the height direction towards the outside and are connected to the housing profile.

9. The battery according to any one of the claims 1 to 8 claim 1, wherein:
the cooler lies on the respective longitudinal wall with the full surface area and is material-bonded to the respective longitudinal wall, and
in the cooler, at least one cooling channel is formed, which is open towards the respective longitudinal wall and closed towards the outside by the respective longitudinal wall.

10. The battery according to claim 1, wherein at least one of:
the battery comprises two coolers, which on the outside each heat-transferringly lie against a respective cooled one of the longitudinal walls and at least one battery stack is heat-insulated from each of the cooled longitudinal walls; and
the battery comprises multiple battery stacks and multiple transverse walls, wherein each battery stack is arranged in each case between two transverse walls following one another in the longitudinal direction and heat-transferringly lies against the transverse walls.

11. The battery according to claim 2, wherein the at least one battery stack is received in a support cage of a heat-insulating material, wherein the support cage, towards the respective longitudinal wall, has a frame-like or grid-like or closed cage longitudinal wall each, and towards the respective transverse wall, a cage transverse wall with an open heat transfer region each.

12. The battery according to claim 3, wherein the at least one battery stack is received in a support cage of a heat-insulating material, wherein the support cage, towards the respective longitudinal wall, has a frame-like or grid-like or closed cage longitudinal wall each, and towards the respective transverse wall, a cage transverse wall with an open heat transfer region each.

13. The battery according to claim 5, wherein:
the open heat transfer region of the cage transverse wall between the battery stack and the respective adjacent transverse wall is filled with a heat-conductive paste; or
in the open heat transfer region of the cage transverse wall, between the battery stack and the respective adjacent transverse wall, a filler plate of a heat-conductive material with a rib structure or with a closed plate structure is arranged, wherein the filler plate and the cage are formed as a contiguous hybrid component.

14. A battery for a motor vehicle, comprising:
a housing having two longitudinal walls aligned transversely to a width direction and multiple transverse walls aligned transversely to a longitudinal direction, the housing being delimited towards the outside by the longitudinal walls and the transverse walls;
multiple battery stacks each of multiple individual cells, which are stacked against one another in a stack direction, each battery stack being received in the housing between the longitudinal walls and between two transverse walls following one another in the longitudinal direction; and
two coolers through each of which a cooling liquid is flowable, each cooler on an outside heat-transferringly lies against a respective cooled one of the longitudinal walls;
each battery stack is heat-insulated from the cooled longitudinal walls of the housing and heat-transferringly lies against the two transverse walls adjacent to the respective battery stack.

15. The battery according to claim 14, wherein between each cooled longitudinal wall and each battery stack, an insulating element of a heat-insulating material is arranged, and the insulating element on one side lies against the each battery stack and on the other side against the respective cooled longitudinal wall.

16. The battery according to claim 15, wherein one of:
the insulating element is an insulating plate, so that a region between each battery stack and the respective cooled longitudinal wall is completely filled out by the insulating plate; or
the insulating element has a rib structure with multiple ribs spaced apart from one another, so that in a region between each battery stack and the respective cooled longitudinal wall multiple heat-insulating part regions filled with ambient air are formed.

17. The battery according to claim 14, wherein each battery stack is received in a support cage of a heat-insulating material, wherein the support cage, towards the respective longitudinal wall, has a frame-like or grid-like or closed cage longitudinal wall each, and towards the respective transverse wall, a cage transverse wall with an open heat transfer region each.

18. The battery according to claim 17, wherein the heat transfer region is formed in the middle of the cage transverse wall and is delimited radially to the longitudinal direction by a surrounding rim of the cage transverse wall.

19. The battery according to claim 17, wherein:
the open heat transfer region of the cage transverse wall between the respective battery stack and the respective adjacent transverse wall is filled with a heat-conductive paste; or
in the open heat transfer region of the cage transverse wall, between the respective battery stack and the respective adjacent transverse wall, a filler plate of a heat-conductive material with a rib structure or with a closed plate structure is arranged, wherein the filler plate and the cage are formed as a contiguous hybrid component.

20. The battery according to claim 14, wherein the stack direction of the individual cells in the respective battery stack coincides with the width direction of the housing.
